(19) United States
(12) Patent Application Publication
(10) Pub. No.: US 2006/0056424 A1
(43) Pub. Date: Mar. 16, 2006

(54) Packet transmission using output buffer

(76) Inventors: Yolin Lih, San Jose, CA (US); Richard J. Reeve, San Mateo, CA (US); Badruddin N. Lakhat, San Jose, CA (US); Richard L. Schober, Cupertino, CA (US)

Correspondence Address: AVAGO TECHNOLOGIES, INC., P.O. BOX 1920, DENVER, CO, 80201-1920, US

(21) Appl. No.: 10/941,426

(22) Filed: Sep. 15, 2004

(51) Int. Cl. H04L 12/28

(52) U.S. Cl. 370/401; 370/419

(57) ABSTRACT

An interconnect device for transmitting data packets includes a plurality of ports, a hub, an arbiter and an output buffer. The hub connects the plurality of ports. The arbiter is coupled to the hub and controls transmission of data packets between the hub and the ports. The output buffer is in at least one of the ports, and is coupled to the hub over more than one feed such that the output buffer can receive a plurality of data packets in parallel from the hub.

### BACKGROUND

Many existing networking technologies, such as Peripheral Component Interconnect (PCI) architecture, have not kept pace with the development of computer systems. Many such systems are challenged by the ever increasing traffic and demands of the Internet. Several technologies have been implemented in an attempt to meet the computing demands and require increased capacity to move data between processing nodes, such as servers, as well as within a processing node between a central processing unit (CPU) and input/output (I/O) devices.

In an attempt to meet these demands, improved interconnect technology has been implemented. One such example is called InfiniBand® architecture (hereinafter “IBA”). IBA is centered around point-to-point, switched fabric in which end node devices may be interconnected utilizing a cascade of switch devices. IBA may be implemented to interconnect numerous hosts and various I/O units, or between a CPU and a number of I/O modules. Interconnect technologies such as IBA, utilize switches, routers, repeaters and/or adaptors having multiple input and output ports through which data (or data packets) is directed from a source to a destination.

For example, a switching device may have multiple input ports and output ports coupled by a crossbar. Multiple data packets received at the input ports require directions that specify output ports, and thus, compete for at least input, output and crossbar resources. An arbitration scheme must be employed to arbitrate between competing requests for resources. As demand on these crossbar switches increase with higher bandwidth and speed requirements, these crossbar switches must increase in performance to keep up. In some cases, the speed at which data packets can be transmitted through these crossbar switches is limited. For these and other reasons, a need exists for the present invention.

### SUMMARY

One aspect of the present invention provides an interconnect device for transmitting data packets includes a plurality of ports, a hub, an arbiter and an output buffer. The hub connects the plurality of ports. The arbiter is coupled to the hub and controls transmission of data packets between the hub and the ports. The output buffer is in at least one of the ports, and is coupled to the hub over more than one feed such that the output buffer can receive a plurality of data packets in parallel from the hub.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram illustrating a network system.

FIG. 2 is a block diagram illustrating a crossbar switch.

FIG. 3 is a block diagram illustrating further details of a crossbar switch.

FIG. 4 is a block diagram illustrating a crossbar switch according to an embodiment of the present invention.

FIG. 5 illustrates an output buffer in accordance with the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

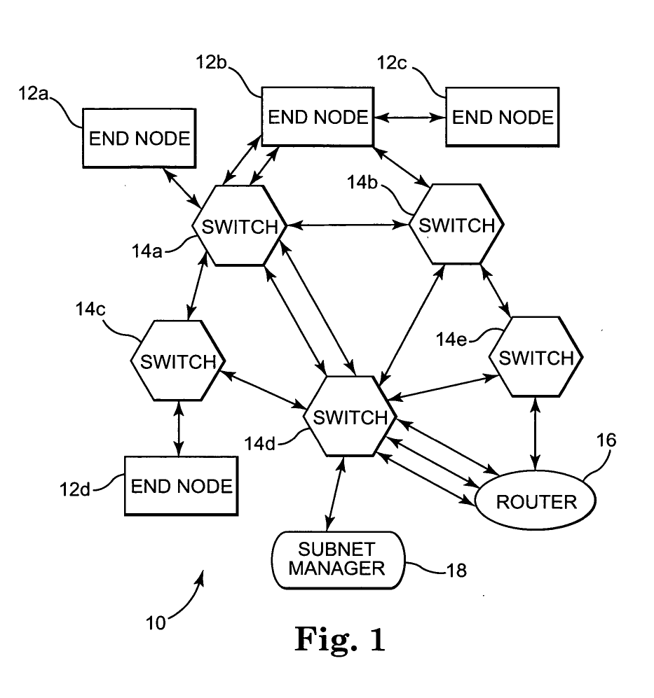

FIG. 1 is a block diagram illustrating a network system 10. Network 10 may be a network or a sub-network, also referred to as a subnet, which is interconnected by routers to other subnets to form a larger network. Within network 10, end nodes may connect to a single subnet or multiple subnets. Network 10 may be any type of switched network. For example, network 10 could be an InfiniBand® architecture (hereinafter “IBA”) defining a switched communications fabric that allows multiple devices to concurrently communicate with high bandwidth and low latency in a protected and remotely managed environment. An InfiniBand® Trade Association has developed and published an IBA specification that details the interconnect technology standards of operation. Other switched networks are also represented by network 10

Network 10 illustrates four end nodes 12a, 12b, 12c, and 12d located within network 10. As known by those of ordinary skill in the art, an end node may represent a number of different devices, examples of which include, a processor end node, a router to a network, or an I/O device, such as a redundant array of independent disks (RAID) subsystem. Also illustrated are switches 14a, 14b, 14c, 14d, and 14e. Furthermore, network 10 includes router 16 and a subnet manager 18. Multiple links can exist between any two devices within network 10, an example of which is shown by connections between router 16 and switch 14d.

Switches 14a, 14b, and 14c connect the end nodes 12a, 12b, 12c, and 12d for communication purposes. Each connection between an end node 12a, 12b, 12c, and 12d and a switch 14a, 14b, and 14c is a point-to-point serial connection. Since the connections are serial, four separate connections are required to connect the end nodes 12a, 12b, 12c, and 12d to switches 14a, 14b, and 14c, as opposed to the requirement of a wide parallel connection used within a PCI bus.

It should be noted that more than four separate connections are illustrated in FIG. 1 to provide examples of different connections within network 10. In addition, since each point-to-point connection is dedicated to two devices, such as end nodes 12a, 12b, 12c, and 12d and switches 14a, 14b, 14c, 14d, and 14e, the full bandwidth capacity of each connection is made available for communication between the two devices. This dedication eliminates contention for a bus, as well as delays that result from heavy loading conditions on a shared bus architecture.

It should also be noted that more or fewer end nodes 12a, 12b, 12c, and 12d may be located within network 10. Router 16 provides a connection from the network 10 to remote subnets for the transmission and reception of data packets. In addition, the end nodes 12a, 12b, 12c, and 12d may be any logical device that is located within the network 10. As an example, the end nodes 12a, 12b, 12c, and 12d may be processor nodes and/or I/O devices.

Due to the structure of switches 14a, 14b, 14c, 14d, and 14e and functionality performed therein, each are capable of controlling the flow of data packets either from an end node 12a, 12b, 12c, and 12d to another end node 12a, 12b, 12c, and 12d, from an end node 12a, 12b, 12c, and 12d to the router 16, or from the router 16 to an end node 12a, 12b, 12c, and 12d.

Switches 14a, 14b, 14c, 14d, and 14e transmit packets of data based upon a destination address, wherein the destination address is located in a local route header of a data packet. However, switches 14a, 14b, 14c, 14d, and 14e are not directly addressed in the traversal of packets within network 10. Instead, packets traverse switches 14a, 14b, 14c, 14d, and 14e virtually unchanged. To this end, each destination within network 10 is typically configured with one or more unique local identifiers, which represent a path through a switch 14a, 14b, 14c, 14d, and 14e.

Data packet forwarding by a switch 14a, 14b, 14c, 14d, and 14e is typically defined by forwarding tables located within each switch 14a, 14b, 14c, 14d, and 14e, wherein the table in each switch is configured by subnet manager 18. Each data packet contains a destination address that specifies the local identifier for reaching a destination. When individual data packets are received by a switch 14a, 14b, 14c, 14d, and 14e, the data packets are forwarded within the switch 14a, 14b, 14c, 14d, and 14e to an outbound port or ports based on the destination local identifier and the forwarding table located within the switch 14a, 14b, 14c, 14d, and 14e.

Router 16 forwards packets based on a global route header located within the packet, and replaces the local route header of the packet as the packet passes from subnet to subnet. While intra-subnet routing is provided by the switches 14a, 14b, 14c, 14d, and 14e, router 16 is the fundamental routing component for inter-subnet routing. Therefore, routers interconnect subnets by relaying packets between the subnets until the packets arrive at a destination subnet. As additional devices, such as end nodes, are added to a subnet, additional switches are normally required to handle additional packet transmission within the subnet. However, it would be beneficial if additional switches were not required with the addition of end nodes, thereby reducing the expenditure of resources associated with the purchase of additional switches.

As stated above, network 10 may be illustrated by way of example as IBA. Thus, network 10 is capable of providing flow control of data packets within a network, such as an IBA, using IBA switches. It should be noted, however, that it is not required that the switch be utilized in association with an IBA. In addition, due to structure of switches such as an IBA switch, the illustrated switches may be easily modified to compensate for the addition of end nodes to network 10, as well as added packet flow associated with the addition of end nodes. On skilled in the art will recognize that other crossbar and related switches can be used in network 10.

Switches 14a, 14b, 14c, 14d, and 14e are transparent to end nodes 12a, 12b, 12c, and 12d, meaning they are not directly addressed (except for management operations). Instead, packets transverse the switches 14a, 14b, 14c, 14d, and 14e virtually unchanged. To this end, every destination within network 10 is configured with one or more unique local identifiers (LID). From the point of view of a switch 14, a LID represents a path through the switch. Packets contain a destination address that specifies the LID of the destination. Each switch 14a, 14b, 14c, 14d, and 14e is configured with forwarding tables (not shown) that dictate the path a packet will take through the switch 14a, 14b, 14c, 14d, and 14e based on a LID of the packet. Individual packets are forwarded within a switch 14a, 14b, 14c, 14d, and 14e to an out-bound port or ports based on the packet's destination LID and the switch's 14a, 14b, 14c, 14d, and 14e forwarding table. IBA switches support unicast forwarding (delivery of a single packet to a single location) and may support multicast forwarding (delivery of a single packet to multiple destinations).

The subnet manager 18 configures the switches 14a, 14b, 14c, 14d, and 14e by loading the forwarding tables into each switch 14a, 14b, 14c, 14d, and 14e. To maximize availability, multiple paths between end nodes 12a, 12b, 12c, and 12d may be deployed within the switch fabric. If multiple paths are available between switches 14a, 14b, 14c, 14d, and 14e, the subnet manager 18 can use these paths for redundancy or for destination LID based load sharing. Where multiple paths exist, the subnet manager 18 can re-route packets around failed links by re-loading the forwarding tables of switches in the affected area of the fabric.

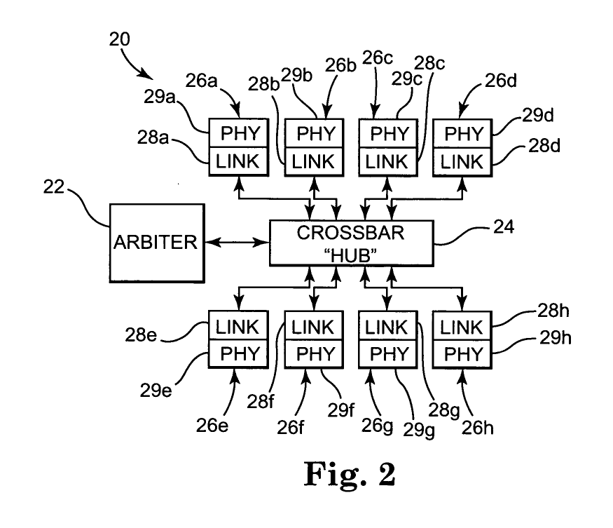

FIG. 2 is a block diagram further illustrating a switch 20, such as switches 14a, 14b, 14c, 14d, and 14e of FIG. 1, in accordance with the exemplary embodiment of the invention. Switch 20 includes an arbiter 22, a crossbar or “hub” 24, and a series of ports 26a-26h (collectively referred to as “ports 26”). For exemplary purposes, eight ports 26 are provided within switch 20. It should be noted that more or fewer ports 26 may be located within switch 20, depending upon the number of end nodes and routers connected to switch 20. In accordance with the exemplary embodiment of the invention, the total number of ports 26 within switch 20 is the same as the total number of end nodes and the total number of routers connected to switch 20. Therefore, as end nodes are added to network 10 (FIG. 1), ports 26 are also added to switch 20. As a result, additional switches are not required to accommodate additional end nodes. Instead, an additional port is added to accommodate an additional end node, as well as functionality for interaction within switch 20, as is described below.

Switch 20 directs a data packet from a source end node to a destination end node, while providing data packet flow control. As is known by those having ordinary skill in the art, a data packet contains at least a header portion, a data portion, and a cyclic redundancy code (CRC) portion. The header portion contains at least a source address portion, a destination address portion, a data packet size portion and a virtual lane identification number. In addition, prior to transmission of the data packet from an end node, a CRC value for the data packet is calculated and appended to the data packet.

In switch 20, ports 26a-26h are connected through hub 24. Each port 26 of switch 20 generally comprises a link block 28a-28h (collectively referred to as “link blocks 28”) and a physical block (“PHY”) 29a-29h (collectively referred to as “PHY blocks 29”). In one embodiment, hub 24 is a ten port device with two ports being reserved for management functions. For example, these may include a management port and a Built-In-Self-Test (BIST) port. FIG. 2 illustrates only eight ports 26a through 26h for clarity of presentation. The eight communication ports 26a through 26h are coupled to hub 24 and each issue resource requests to arbiter 22, and each receive resource grants from arbiter 22. As one skilled in the art will recognize, more or less ports 26 may be used.

PHY blocks 29 primarily serve as serialize to de-serialize (“SerDes”) devices. Link blocks 28 perform several functions, including input buffer, receive (“RX”), transmit (“TX”), and flow control. Input virtual lanes (VLs) are physically contained in input buffers (not shown) of link blocks 28. Other functions that may be performed by link blocks 28 include: integrity checking, link state and status, error detecting and recording, flow control generation, and output buffering.

In one embodiment, hub 24 is implemented as a sparsely populated data path structure. In essence, the hub 24 acts as a distributed MUX for every possible input to each output port. Hub 24 is combinatorial and capable of completing the switching process for one 32-bit word within one 250 MHz system clock period (4.0 ns).

While hub 24 interconnects ports 26a-26h, arbiter 22 controls interconnection between ports 26a-26h via hub 24. Specifically, hub 24 contains a series of wired point-to-point connections that are capable of directing data packets from one port 26 to another port 26, from port 26 to arbiter 22, and/or from arbiter 22 to port 26. Arbiter 22 contains a request preprocessor and a resource allocator. The request preprocessor determines a port 26 within switch 20 that is to be used for transmitting a received data packet to a destination end node. It should be noted that the port 26 to be used for transmitting received data packets to the destination end node is also referred to herein as the outgoing port.

For exemplary purposes, the following assumes that the outgoing port is port 26d and that a source port is port 26a. To determine the outgoing port 26d, the request preprocessor uses a destination address stored within the header of the received data packet to index a routing table located within the request preprocessor and determine the outgoing port 26d for the received data packet. It should be noted that each port 26a-26h is capable of determining a destination address of a received data packet. As is further explained below, the arbiter 22 also determines availability of the outgoing port 26d and regulates transmission of received data packets, via switch 20, to a destination end node.

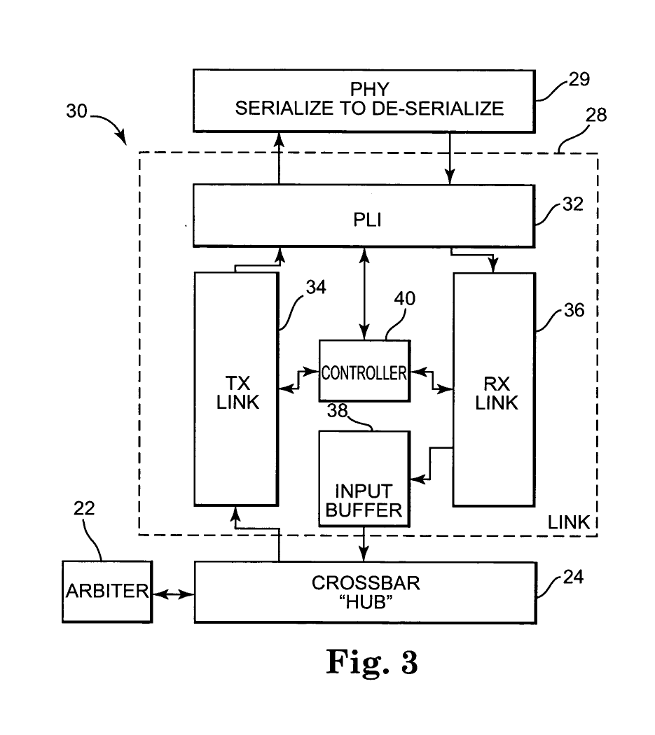

FIG. 3 is a block diagram illustrating a portion of switch 30. More specifically, FIG. 3 is a more detailed view of switch 20 illustrated in FIG. 2, providing more detail of link blocks 28. It will be appreciated by those of ordinary skill in the relevant arts that switch 30, as illustrated in FIG. 3, and the operation thereof as described hereinafter is intended to be generally representative of such systems and that any particular switch may differ significantly from that shown in FIG. 3, particularly in the details of construction and operation. Further, only those functional elements that have bearing on the present invention have been portrayed so as to focus attention on the salient features of the inventive features. As such, switch 30 is to be regarded as illustrative and exemplary and not limiting in regard to the invention described herein or the claims attached hereto.

Link block 28 generally comprises a phy-link interface 32 (the “PLI”) connected to a transmit link (the “Tx link”) 34 and a receive link (the “Rx link”) 36. The Rx link 36 outputs to an input buffer 38 for transfer of data to the hub 24. A controller 40 controls the operation of Tx link 34 and Rx link 36.

PLI 32 connects transmitter and receiver portions of PHY block 29 to Tx link 34 and Rx link 36, respectively, of link block 28. The receiver portion of PLI 32 realigns the data from the PHY block 29 and detects special characters and strings of characters, such as a start of packet (SOP) indicator and an end of packet (EOP) indicator, from the receiver data stream. Rx link 36 accepts packet data from the PLI 32, performs certain checks, and passes the data on to input buffer 38. Tx link 34 sends data packets that are ready to transfer from hub 24 to the PHY block 29 through PLI 32. In doing so, Tx link 34 realigns the data, adds the placeholder for the start/end packet (SOP/EOP) control characters, and calculates and inserts the VCRC field. In addition to data packets, Tx link 34 also accepts and transmits flow control link packets from a flow control state machine (not shown).

In one embodiment, when a packet transfer request reaches the resource allocator within arbiter 22, it specifies an input port 26a, an output port 26d (again, these ports used for exemplary purposes) through which the packet is to exit switch 20, the virtual lane on which the packet is to exit, and the length of the packet. If, and when, the path from the input port 26a to the output port 26d is available, and there are sufficient credits from the downstream device, the resource allocator of arbiter 22 will issue a grant. If multiple requests are targeting the same port 26d, the resource allocator of arbiter 22 uses a specified arbitration protocol to control the routing. For example, arbitration protocol described in the Infiniband® Architecture Specification can be used for controlling packet transmission to the output ports.

In switches where the output port has one feed-in from the hub, the output port 26d accepts only one packet at a time. While the output port 26d is accepting one packet, it will provide a busy signal, or Tx busy signal, indicating to arbiter 22 that it cannot accept additional packets at that time. Thus, when multiple packets from input ports are to be sent to the same output port 26d, the packets must be buffered and a grant sequence number is then assigned to the packets by arbiter 22. In this way, when output port 26d is finished transmitting the current packet and the Tx busy signal is suppressed, the packet with the next grant sequence number can be sent to the output port 26d for transmission. If the output port speed is faster than the speed of the packet stream, however, the output port suffers performance through outbound bandwidth loss in such a switch with one feed-in from the hub.

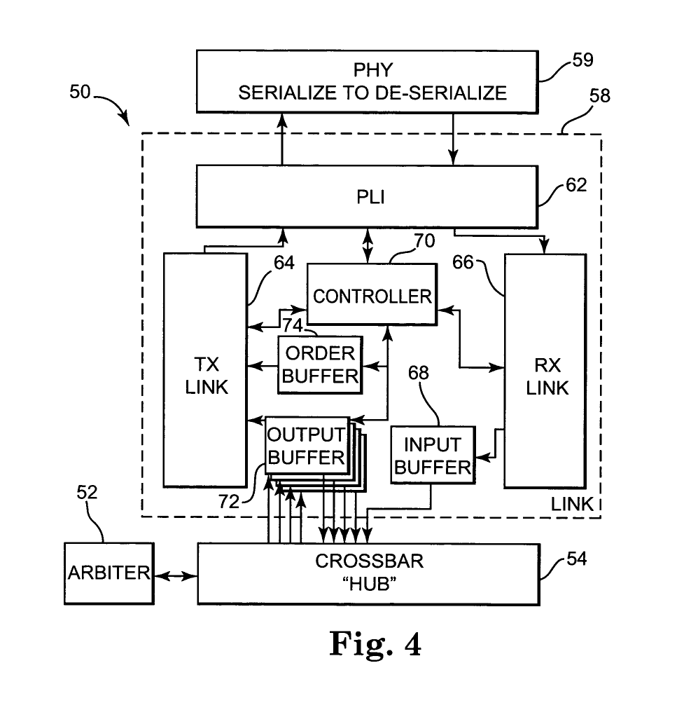

FIG. 4 is a block diagram illustrating a portion of switch 50 in accordance with the present invention. As with switches 20 and 30 described above, switch 50 includes a multitude of ports that are connected through hub 54. Each port of switch 50 generally comprises a link block 58 and a physical block (“PHY”) 59 (only a single link block 58 and PHY block 59 representing a single port are illustrated in FIG. 4). In one embodiment, hub 54 is a ten port device with eight communication ports and two ports being reserved for management functions, as described above. As will be recognized by one skilled in the art, a variety of switches 50 with different numbers of ports are possible. The communication ports are coupled to hub 54 and each issue resource requests to arbiter 52, and each receive resource grants from arbiter 52.

FIG. 4 illustrates view of switch 50 that providing more detail of link block 58 in accordance with the present invention. Link block 58 generally comprises a phy-link interface 62 (the “PLI”) connected to a transmit link (the “Tx link”) 64 and a receive link (the “Rx link”) 66. The Rx link 66 outputs to an input buffer 68 for transfer of data to the hub 54. A controller 70 controls the operation of Tx link 64 and Rx link 66. Arbiter 52 controls interconnection between ports via hub 54 as explained above with respect to switches 20 and 30.

In addition, link block 58 of switch 50 includes output buffer 72 and order buffer 74. In one embodiment, output buffer 72 appears functionally to hub 54 as four output buffers, each of which is coupled to hub 54 over a separate feed-in or bus. In this way, link block 58 switch 50 allows more than one feed-in to the output port from hub 54. In this way, hub 54 can deliver multiple data packet streams in parallel to the output port. In this way, there is less contention for output ports in switch 50 than there is in conventional switches where the output port has one feed-in from the hub such that the output port accepts only one packet at a time. This involves less intervention and arbitration from arbiter 52 resulting in improved outbound bandwidth for data packets.

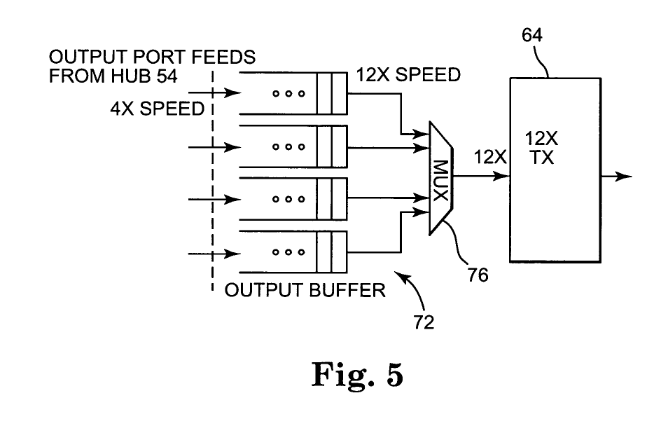

FIG. 5 further illustrates output buffer 72 in accordance with the present invention. Hub 54 transmits data packets to output buffer 72 via the four feeds available in output buffer 72. Each feed allows independent transfer of data packets from hub 54 to the output port. Data packets are then transmitted to Tx link 64 via multiplexer (“MUX”) 76. As with conventional switches, arbiter 52 arbitrates data packets when multiple packets are to be sent to the same output port. A grant sequence is assigned to the packets and data packets are then sent to the output port when the sequence number comes up. In prior switches, if four packets to be sent to the same output port, and thus assigned grant sequence packet no. 1, packet no. 2, packet no. 3 and packet no. 4, they will be sent sequentially one after another in that sequence. With switch 50, all four packets are sent in parallel over the four feeds in output buffer 72.

In one embodiment, the order of the grant sequence assigned by arbiter 52 is maintained even though each packet is initially feed in parallel. This maintenance of the grant sequence may be accomplished in a variety of ways. In one embodiment, although the packets sent in parallel on the four feeds of output port 72, the packets with a higher grant sequence may be delayed, for example, one cycle relative to the others. In this way, the SOP for each of the packets will maintain the order of the sequences. Thus, in such a switch 50, arbiter 52 must only wait for the SOP of the packet currently being transmitted from hub 54 to the output port in order to trigger the transfer the next packet in the sequence, rather that having to wait until the EOP of the current packet as with prior switches.

In one embodiment, the sequence is also maintained out of the output port. In this way, the order buffer 74 may be used to reorder packets that may otherwise become out of order, for example, because it takes longer for some of the packets to be received in output buffer 72. For example, for the data packets with assigned grant sequence packet no. 1, packet no. 2, packet no. 3 and packet no. 4 above, the SOP for packet no. 1 in the sequence will be received before packet no. 2 in the sequence, but EOP for packet no. 2 may be received before EOP for packet number 1, for example, when packet no. 2 is shorter relative to packet no. 1. In this case, controller 70 may use order buffer 74 (illustrated in FIG. 4) to reorder the packets so that packets are transmitted out of output buffer 72 to Tx link 64 in the maintained sequence assigned by arbiter 52. This embodiment can be referred to as a “First Read First Go” output buffer. In other words, a packet is streamed out only after the EOP is received, but the out-stream order is tagged on receiving the SOP.

In other embodiments, packets may be transmitted out of output buffer 72 to Tx link 64 in the order in which they are completed. In other words, the EOP for the packets will determine the sequence that the packets are transmitted. Other configurations are also possible; switch 50 must simply be properly configured to execute the desired protocol.

As described above, the protocol in the arbitrator, such as arbitration protocol described in the Infiniband® Architecture Specification, administrates traffic flow among the ports. The protocol also maintains the transmission ordering among the packets. In this way, there is no need for packet arbitration logic inside the output ports in switch 50. This maintains simplicity in the ports of switch 50. Switch 50, with output buffer 72 and order buffer 74, improves overall performance with increase throughput and improved cut-through latency. It requires less arbitration up front and decreases data packet collisions relative to conventional switches.

In one embodiment, switch 50 is an IBA switch. As such switch 50 provides for operation at 1×, 4×, or 12× port speeds. In this IBA embodiment, output buffer 72 is in the 12× output port and is a store-and-forward FIFO between hub 52 and the 12× PLI block 62. It converts four 4× output streams from hub 52 into one 12× stream to the 12× PLI block 62. Functionally, to hub 52, output buffer 72 is four 4× output ports, while to the 12× output port, it is an extension of hub 52, but with 12× data bus width.

In one embodiment where switch 50 is an IBA switch, output buffer 72 may be four 512-entry×120-bit packet FIFOs with associated control logic. One FIFO is used for each receiving stream from hub 54. Order buffer 74 is a 128-entry×4-bit reorder FIFO with associated control logic. The control logic is a responsible agent for reading the packet buffer data. Controller 70 performs functions such as accepting flow control packets, inserting packet delimiters, vcrc generation, and idle insertion.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An interconnect device for transmitting data packets, the interconnect device comprising:
a plurality of ports;
a hub connecting the plurality of ports;
an arbiter coupled to the hub for controlling transmission of data packets between the hub and the ports; and
an output buffer in at least one of the ports, the output buffer coupled to the hub over more than one feed such that the output buffer can receive a plurality of data packets in parallel from the hub.

2. The interconnect device of claim 1, wherein the output buffer receives and holds more than one data packet before transmitting the data packet out of the port.

3. The interconnect device of claim 1, wherein each of the plurality of ports further comprise a physical block and a link block.

4. The interconnect device of claim 3, wherein the output buffer is contained in the link block of each of the plurality of ports.

5. The interconnect device of claim 3, wherein the link block further comprises a phy-link interface, a transmit link and a receive link, wherein the output buffer is coupled to the transmit link, the transmit link is coupled to the phy-link and the phy-link is coupled to the physical block such that data packets are transmitted out of the output buffer to the transmit link, then to the phy-link, and then to the physical block.

6. The interconnect device of claim 1, wherein the arbiter assigns a grant sequence number to each of the data packets transmitted over the hub.

7. The interconnect device of claim 6 further comprising an order buffer coupled to the output buffer.

8. The interconnect device of claim 7, wherein the output buffer transmits data packets to the order buffer to reorder packets that are received out of the grant sequence assigned by the arbiter.

9. The interconnect device of claim 6, data packets are streamed out of the output buffer in an order based on the sequence assigned by the arbiter and based on start of packet.

10. The interconnect device of claim 6, data packets are streamed out of the output buffer in an order based on the sequence assigned by the arbiter and based on end of packet.

11. The interconnect device of claim 6, wherein the output buffer is a “first read first go” output buffer such that data packets are streamed out of the output buffer only after an end of packet is received, but where an out-stream order is tagged when a start of packet is received.

12. The interconnect device of claim 1, wherein the interconnect device is in InfiniBand switch.

13. An InfiniBand switch in an InfiniBand network device for transmitting data packets, the InfiniBand switch comprising:
a plurality of ports;
a hub connecting the plurality of ports;
an arbiter coupled to the hub for controlling transmission of data packets between the hub and the ports; and
means for transmitting a plurality of data packets to a single output port in parallel.

14. The InfiniBand switch of claim 13, wherein the means for transmitting includes an output buffer coupled to the hub and wherein the output buffer receives and holds more than one data packet before transmitting the data packet out of the port.

15. The InfiniBand switch of claim 14, wherein output buffer is coupled to the hub over parallel feeds that are independently connected between the output buffer and the hub.

16. The InfiniBand switch of claim 13, wherein the means for transmitting includes an order buffer coupled to the output buffer.

17. The interconnect device of claim 16, wherein the output buffer transmits data packets to the order buffer to reorder packets that are received out of a grant sequence assigned by the arbiter.

18. A method for transmitting data packets through an interconnect device with a plurality of ports connected by a hub comprising:
transmitting multiple data packets from input ports to a designated output port via the hub;
assigning a grant sequence to the multiple data packets to be transmitted to the designated output port such that the data packets have a sequence according to the assigned grant sequence;
transmitting the multiple data packets to the designated output port via separate feed lines such that the designated output port can receive more than one data packet at one time;
buffering the multiple data packets in the designated output port; and
transmitting the multiple data packets out of the output port.

19. The method of claim 18 wherein the InfiniBand switch is coupled in a subnetwork such that data packets are transferred into InfiniBand switch via the input port and out of the InfiniBand switch via the output port.
